(19) United States
(12) Patent Application Publication
(10) Pub. No.: US 2007/0238794 A1
(43) Pub. Date: Oct. 11, 2007

(54) Synergistic Flame-Proof Mixtures for Polystyrene Foams

(75) Inventors: Klaus Hahn, Kirchheim (DE); Gerd Ehrmann, Deidesheim (DE); Joachim Ruch, Wachenheim (DE); Markus Allmendinger, Meckenheim (DE); Bernhard Schmied, Frankenthal (DE); Jan Holoch, Leimen (DE); Paulus Schmaus, Ludwigshafen (DE)

Correspondence Address: CONNOLLY BOVE LODGE & HUTZ LLP, 1875 EYE STREET, N.W., SUITE 1100, WASHINGTON, DC, 20036, US

(73) Assignee: BASF Aktiengesellschaft, Ludwigshafen (DE)

(21) Appl. No.: 11/632,416

(22) PCT Filed: Jul. 8, 2005
(86) PCT No.: PCT/EP05/07399

§ 371 Date: Jan. 12, 2007

(30) Foreign Application Priority Data
Jul. 15, 2004 (DE) 10 2004 034 514.7

(51) Int. Cl. C08K 5/02; B29C 47/10; C08J 9/00; C08K 5/00

(52) U.S. Cl. 521/80

(57) ABSTRACT

A process for producing flame-resistant, expandable styrene polymers (EPS) or flame-resistant extruded styrene polymer foams (XPS), wherein an organic bromine compound having a bromine content of at least 70% by weight is used as flame retardant and a liquid peroxide, hydroperoxide or a peroxide solution is used as flame retardant synergist.

The invention relates to a process for producing flame-resistant, expandable styrene polymers (EPS) or flame-resistant extruded styrene polymer foams (XPS), in which an organic bromine compound having a bromine content of at least 70% by weight is used as flame retardant and a liquid peroxide or hydroperoxide or a peroxide solution is used as flame retardant synergist.

Processes for producing flame-resistant, expandable styrene polymers by extrusion of a styrene polymer melt containing blowing agent are known, for example, from EP-A 0 981 574, WO 97/45477 or WO 03/46016. Here, the flame retardant is, if appropriate with further additives, melted with polystyrene and a blowing agent is subsequently added.

Flame retardant synergists used here for halogenated flame retardants such as hexabromocyclododecane (HBCD) are generally thermal free-radical formers, e.g. dicumyl peroxide or bicumyl. Dicumyl peroxide and bicumyl can be added as pulverulent solids to the polystyrene matrix in an extrusion process only in a pressurized chamber.

In the extrusion process, the temperature stress on the heat-sensitive peroxides is increased as a result of the residence time and local, shear-induced temperature peaks. Peroxides having a low half-life at temperatures of from 150 to 250° C. are therefore not very suitable. For this reason, bicumyl is preferred over dicumyl peroxide as flame retardant synergist in the production of extruded polystyrene foams (XPS) despite its higher price and lower effectiveness because of its significantly higher half-life.

Expanded polystyrene foams having a particularly low residue styrene and ethylbenzene content are of interest in many applications. These include products which come into contact with food and also foam moldings in automobile applications. Low residue styrene and ethylbenzene contents reduce fogging, which is a disadvantageous property which is of particular importance for applications in the automobile sector.

In the suspension polymerization used hitherto for EPS production, low residue styrene contents can only be achieved by means of long polymerization times at a high temperature level. This has a very disadvantageous effect on the polymerization cycle time.

It was therefore an object of the present invention to remedy the abovementioned disadvantages and provide a process for producing flame-resistant, expandable styrene polymers (EPS) and flame-resistant extruded styrene polymer foams (XPS) in which the flame retardant synergist can be introduced simply and under mild conditions.

We have accordingly found the process described at the outset.

It has been found that styrene polymers having molecular weights M_{w} of less than 170 000 lead to polymer attrition during pelletization. The expandable styrene polymer preferably has a molecular weight in the range from 190 000 to 400 000 g/mol, particular preferably in the range from 220 000 to 300 000 g/mol. Owing to the decrease in the molecular weight caused by shear and/or heat, the molecular weight of the expandable polystyrene is generally about 10 000 g/mol below the molecular weight of the polystyrene used.

To obtain very small pellets, the die swell at the exit from the die should be very small. It has been found that the die swell can be influenced, inter alia, by the molecular weight distribution of the styrene polymer. The expandable styrene polymer should therefore preferably have a molecular weight distribution having a polydispersity M_{w}/Mₙ of not more than 3.5, particularly preferably in the range from 1.5 to 3 and very particularly preferably in the range from 1.8 to 2.6.

Styrene polymers used are preferably clear polystyrene (GPPS), high-impact polystyrene (HIPS), anionically polymerized polystyrene or high-impact polystyrene (A-IPS), styrene-α-methylstyrene copolymers, acrylonitrile-butadiene-styrene polymers (ABS), styrene-acrylonitrile (SAN), acrylonitrile-styrene-acrylate (ASA), methacrylate-butadiene-styrene (MBS), methyl methacrylate-acrylonitrile-butadiene-styrene (MABS) polymers or mixtures thereof or with polyphenylene ether (PPE).

To improve the mechanical properties or the heat resistance, the styrene polymers mentioned can be blended with thermoplastic polymers such as polyamides (PA), polyolefins such as polypropylene (PP) or polyethylene (PE), polyacrylates such as polymethyl methacrylate (PMMA), polycarbonate (PC), polyesters, such as polyethylene terephthalate (PET) or polybutylene terephthalate (PBT), polyether sulfones (PES), polyether ketones or polyether sulfides (PES) or mixtures thereof in proportions of generally up to a maximum total amount of 30% by weight, preferably in the range from 1 to 10% by weight, based on the polymer melt, if appropriate using compatibilizers. Furthermore, mixtures in the quantity ranges specified with, for example, hydrophobically modified or functionalized polymers or oligomers, rubbers such as polyacrylates or polydienes, e.g. styrene-butadiene block copolymers, or biodegradable aliphatic or aliphatic/aromatic copolyesters are also possible.

Suitable compatibilizers are, for example, styrene copolymers modified with maleic anhydride, polymers containing epoxide groups or organosilanes.

Recycled material composed of the thermoplastic polymers mentioned, in particular styrene polymers and expandable styrene polymers (EPS), can also be added to the styrene polymer melt in amounts which do not have a significant adverse effect on the properties, generally in amounts of not more than 50% by weight, in particular in amounts of from 1 to 20% by weight.

The blowing agent-containing styrene polymer melt generally comprises one or more blowing agents which are homogeneously distributed and are present in a total amount of from 2 to 10% by weight, preferably from 3 to 7% by weight, based on the styrene polymer melt containing blowing agent. Suitable blowing agents are the physical blowing agents customarily used in EPS, e.g. aliphatic hydrocarbons having from 2 to 7 carbon atoms, alcohols, ketones, ethers or halogenated hydrocarbons. Preference is given to using isobutane, n-butane, isopentane, n-pentane.

To improve the foamability, finely divided internal water droplets can be introduced into the styrene polymer matrix. This can be achieved, for example, by addition of water to the molten styrene polymer matrix. The addition of water can be carried out locally before, together with or after the addition of blowing agent. Homogeneous distribution of the water can be achieved by means of dynamic or static mixers.

An amount of from 0 to 2% by weight, preferably from 0.05 to 1.5% by weight, of water, based on the styrene polymer, is generally sufficient.

Expandable styrene polymers (EPS) in which at least 90% of the internal water is in the form of internal water droplets having a diameter in the range from 0.5 to 15 pm form foams having a sufficient number of cells and a homogeneous foam structure on foaming.

The added amount of blowing agent and water is chosen so that the expandable styrene polymers (EPS) have an expansion capability a defined as bulk density before foaming/bulk density after foaming of not more than 125, preferably from 25 to 100. The expandable styrene polymer pellets (EPS) produced according to the invention generally have a bulk density of not more than 700 g/l, preferably in the range from 590 to 660 g/l. When fillers are used, bulk densities in the range from 590 to 1200 g/l can occur, depending on the type and amount of filler.

As flame retardants, use is made of organic bromine compounds having a bromine content of at least 70% by weight. Aliphatic, cycloaliphatic and aromatic bromine compounds such as hexabromocyclododecane, pentabromomonochlorocyclohexane, pentabromophenyl allyl ether are particularly useful. The flame retardant is generally used in amounts of from 0.2 to 5% by weight, preferably from 0.5 to 2.5% by weight, based on the styrene polymer.

Suitable flame retardant synergists are thermal free-radical formers which have half-lives of 6 minutes at temperatures in the range from 110 to 300° C., preferably from 140 to 230° C., and are liquid or soluble in water, hydrocarbons or white oil. Preference is given to using di-tert-butyl peroxide (Trigonox® B), tert-butyl hydroperoxide (Trigonox® A80), a solution of dicumyl peroxide in pentane or an aqueous solution of a peroxide or hydroperoxide as flame retardant synergist. The flame retardant synergist is preferably used in pure form or, in the case of solids, in a solution which is virtually saturated under normal conditions (1 bar, 23° C.) so that it can be metered directly by means of classical pumping systems into a heated and pressurized chamber. The presence of the flame retardant synergist in a liquid phase makes it possible for metering to be carried out so that, even in the case of low-decomposing peroxides, sufficient amounts survive the process or extrusion conditions and homogeneous mixing is nevertheless achieved. In general, the flame retardant synergist is used in amounts in the range from 0.05 to 1% by weight, preferably in the range from 0.1 to 0.5% by weight.

With the exception of water-soluble hydroperoxides, the process of the invention can also be used in the production of flame-resistant, expandable styrene polymers by the suspension process. In the suspension, the use of liquid peroxides makes safe handling possible owing to the pumpability and ready homogenization in the organic phase.

The process of the invention is preferably used for producing flame-resistant, expandable styrene polymers (EPS) by premixing the flame retardant with a proportion of styrene polymer melt in a side extruder and metering it into the main stream of a styrene polymer melt containing blowing agent and extruding the combined stream through a die plate with subsequent underwater pelletization. The flame retardant synergist is preferably metered directly into the main stream via a pump and metering lance at the same height.

Here, the residence time of the flame retardant and of the flame retardant synergist at a melt temperature in the range from 140 to 220° C., preferably in the range from 170 to 200° C., can be kept below 15 minutes.

In addition, the molecular weight and also the VN of the polymer material can be set via the amount of peroxide/hydroperoxide introduced in the extruder/static mixer. This in turn makes it possible to modify the expandability and the materials properties of the EPS.

Furthermore, additives, nucleating agents, fillers, plasticizers, soluble and insoluble inorganic and/or organic dyes and pigments, e.g. IR absorbers such as carbon black, graphite or aluminum powder, can be added to the styrene polymer melt either together or in separate places, e.g. via the mixer or side extruder. In general, the dyes and pigments are added in amounts in the range from 0.01 to 30% by weight, preferably in the range from 1 to 5% by weight. To achieve homogeneous and microdisperse distribution of the pigments in the styrene polymer, it can be advantageous, particularly in the case of polar pigments, to use a dispersant, e.g. organosilanes, polymers containing epoxy groups or styrene polymers grafted with maleic anhydride. Preferred plasticizers are mineral oils, phthalates, which can be used in amounts of from 0.05 to 10% by weight, based on the styrene polymer.

To produce the expandable styrene polymers according to the invention, the blowing agent is mixed into the polymer melt. The process comprises the steps a) generation of the melt, b) mixing, c) cooling, d) transport and e) granulation. Each of these steps can be effected by means of the apparatuses or apparatus combinations known in plastics processing. Mixing into the melt can be achieved using static or dynamic mixers, for example extruders. The polymer melt can be taken directly from a polymerization reactor or can be generated directly in the mixing extruder or in a separate melting extruder by melting polymer pellets. Cooling of the melt can be effected in the mixing apparatuses or in separate coolers. Suitable methods of pelletization are, for example, pressurized underwater pelletization, pelletization using rotary knives and cooling by spray atomization of cooling liquids or atomization granulation. Suitable apparatus arrangements for carrying out the process are, for example:
a) Polymerization reactor-static mixer/cooler-pelletizer
b) Polymerization reactor-extruder-pelletizer
c) Extruder-static mixer-pelletizer
d) Extruder-pelletizer

Furthermore, the arrangement can have side extruders for the introduction of additives, e.g. solids or heat-sensitive additives.

The styrene polymer melt containing blowing agent is generally conveyed through the die plates at a temperature in the range from 140 to 300° C., preferably in the range from 160 to 240° C. Cooling down to the region of the glass transition temperature is not necessary.

The die plate is heated to at least the temperature of the polystyrene melt containing blowing agent. The temperature of the die plate is preferably 20-100° C. above the temperature of the polystyrene melt containing blowing agent. This prevents polymer deposits in the die openings and ensures trouble-free pelletization.

To obtain marketable pellet sizes, the diameter (D) of the holes in the die at the exit from the die should be in the range from 0.2 to 1.5 mm, preferably in the range from 0.3 to 1.2 mm, particularly preferably in the range from 0.3 to 0.8 mm. This enables pellet sizes of less than 2 mm, in particular in the range from 0.4 to 1.4 mm, to be obtained in a targeted manner, even after die swell.

The die swell can be influenced not only via the molecular weight distribution but also by the die geometry. This die plate preferably has holes having an L/D ratio of at least 2, with the length (L) referring to the region of the holes whose diameter corresponds to not more than the diameter (D) at the exit from the die. The L/D ratio is preferably in the range 3-20.

In general, the diameter (E) of the holes at the entry to the die plate should be at least twice the diameter (D) at the exit from the die.

In one embodiment of the die plate, the holes have a conical inlet and an inlet angle α of less than 180°, preferably in the range from 30 to 120°. In a further embodiment, the die plate has holes having a conical outlet and an outlet angle β of less than 90°, preferably in the range from 15 to 45°. To produce targeted pellet size distributions of the styrene polymers, the die plate can be provided with holes having differing exit diameters (D). The various embodiments of the die geometry can also be combined with one another.

A particularly preferred process for producing expandable styrene polymers comprises the steps
a) polymerization of styrene monomer and if appropriate copolymerizable monomers to form a styrene polymer having a mean molecular weight in the range from 160 000 to 400 000 g/mol,
b) degassing of the styrene polymer melt obtained,
c) mixing of the blowing agent and, if appropriate, additives into the styrene polymer melt by means of static or dynamic mixers at a temperature of at least 150° C., preferably 180-260° C.,
d) cooling of the styrene polymer melt containing blowing agent to a temperature of at least 120° C., preferably 150-200° C.,
e) introduction of the flame retardant via a side extruder,
f) discharge through a die plate having holes whose diameter at the exit from the die is not more than 1.5 mm and
g) pelletization of the melt containing blowing agent.

In step g), pelletization can be carried out directly after the die plate underwater at a pressure in the range from 1 to 25 bar, preferably from 5 to 15 bar.

As a result of the polymerization in step a) and degassing in step b), a polymer melt is available directly for the impregnation with blowing agent in step d) and melting of styrene polymers is not necessary. This is not only economical, but also leads to expandable styrene polymers (EPS) having low styrene monomer contents since the mechanical shearing action in the melting region of an extruder, which generally leads to redissociation to monomers, is avoided. To keep the styrene monomer content low, especially below 500 ppm, it is also advantageous to keep the mechanical and thermal energy input as low as possible in all subsequent process steps. For this reason, particular preference is given to shear rates of less than 50/sec, preferably from 5 to 30/sec, and temperatures below 260° C. and also short residence times in the range from 1 to 20 minutes, preferably from 2 to 10 minutes, in steps d) to f). Particular preference is given to using exclusively static mixers and static coolers in the entire process. The polymer melt can be transported and discharged by means of pressure pumps, e.g. gear pumps.

A further possible way of reducing the styrene monomer content and/or the content of residue solvent such as ethylbenzene is to carry out an intensive degassing by means of entrainers, for example water, nitrogen or carbon dioxide, in step b) or to carry out the polymerization step a) anionically. The anionic polymerization of styrene leads not only to styrene polymers having a low styrene monomer content, but at the same time leads to low styrene oligomer contents.

When peroxides are used as flame retardants, the residue styrene contents of the pellets containing blowing agent are, surprisingly, reduced significantly. When peroxide is added, only a slight reduction in the mean molecular weight is observed, but no significant formation of oligomers or monomers is found. This firstly makes it possible to use polystyrene melts having relatively high residue monomer contents, which in turn means a reduced outlay for degassing downstream of the polystyrene reactor. Secondly, the residue monomer contents of previously largely degassed polystyrene can be reduced further. In this way, EPS pellets having residue monomer contents of less than 250 ppm can be obtained.

To improve the processability, the finished expandable styrene polymer pellets can be coated with glyceryl esters, antistatics or anticaking agents.

The EPS pellets can be coated with glyceryl monostearate GMS (typically 0.25%), glyceryl tristearate (typically 0.25%), finely divided silica Aerosil R972 (typically 0.12%) and Zn stearate (typically 0.15%) and an antistatic.

The expandable styrene polymer pellets produced according to the invention can be prefoamed in a first step by means of hot air or steam to form foam particles having a density in the range from 8 to 100 g/l and be fused in a closed mold in a second step to give foam moldings.

### EXAMPLES

Starting Materials:

PS148 G (polystyrene from BASF AG having a viscosity number VN of 83 ml/g, a mean molecular weight M_{w} of 220 000 g/mol and a polydispersity M_{w}/Mₙ of 2.9)

PS158 K (polystyrene from BASF AG having a viscosity number VN of 98 ml/g, a mean molecular weight M_{w} of 280 000 g/mol and a polydispersity M_{w}/Mₙ of 2.8)

HBCD: hexabromocyclododecane FR-1206 Hat from Eurobrom (flame retardant)

Flame retardant synergists:

di-tert-butyl peroxide (Trigonox® B),

tert-butyl hydroperoxide (Trigonox® A80)

50% strength by weight solution of dicumyl peroxide in pentane

### Examples 1, 2, 4 and 5

A main stream of a polymer melt containing blowing agent (polystyrene 148 G and 7% by weight of n-pentane) was cooled from 260° C. to 190° C. and hexabromocyclododecane (HBCD) which had been premixed with a polystyrene melt in a side extruder was metered into it in accordance with the details given in Table 1 (amounts added in percent by weight, based on polystyrene). At the same height, the flame retardant synergist was metered in by means of a piston pump and metering lance. The resulting polymer melt was conveyed at a throughput of 60 kg/h through a die plate having 32 holes (0.75 mm diameter) and pelletized by means of a pressurized underwater pelletization apparatus to give compacted pellets having a narrow size distribution.

### Examples 3 and 6

Example 1 was repeated using polystyrene 158 K from BASF AG having a viscosity number VN of 98 ml/g, a mean molecular weight M_{w} of 280 000 g/mol and a polydispersity M_{w}/Mₙ of 2.8 in accordance with the details given in Table 1.

### Comparative Experiments C1 to C5

Example 1 or 6 (comparative experiment 2) was repeated with HBCD and/or flame retardant synergist being left out.

### Example 7

Example 1 was repeated with the modification that the flame retardant synergists were metered in together with the flame retardant via the side extruder.

The expandable polystyrene pellets obtained were prefoamed in flowing steam to produce foam particles having a density of about 20 g/l and, after storage for 24 hours, were fused by means of steam in gastight molds to give foam bodies.

After storage of the foam bodies for 72 hours, the burning behavior was determined. For this purpose, a Bunsen burner flame was applied to the foam bodies for 2 seconds in a horizontal burning test and the bodies were subsequently removed from the flame. After-burning times of less than 6 seconds are required to pass the B2 test in accordance with DIN 4102.

The amount of flame retardant (metered addition) and the results of the burning test and the viscosity number VN, measured on the expanded polystyrene foam, are summarized in Table 1. Table 2 shows the foaming behavior in Examples 3 and 4 and in Comparative Experiments C1 and C2.

TABLE 1

| | HBCD [% | Synergist | | | | | Residue |
|---|---|---|---|---|---|---|---|
| | by | [% by | | After-burning | | | styrene |
| Example | weight] | weight] | Synergist | time [sec.] | PS | VN | [ppm] |
| C1 | — | — | — | burns away | 148 G | 79 | 500 |
| C2 | — | — | — | burns away | 158 K | 89 | 540 |
| C3 | — | 0.4 | Trigonox ® A80 | burns away | 148 G | | |
| C4 | — | 0.4 | Trigonox ® B | burns away | 148 G | | |
| C5 | 1.5 | — | — | burns away | 148 G | | |
| 1 | 1.5 | 0.4 | Trigonox ® B | 0.5 | 148 G | | |
| 2 | 0.9 | 0.4 | Trigonox ® B | 1.6 | 148 G | | 219 |
| 3 | 0.6 | 0.2 | Trigonox ® B | 3.8 | 158 K | 80 | 242 |
| 4 | 1.5 | 0.4 | Trigonox ® A80- | 5.6 | 148 G | 74 | |
| 5 | 0.6 | 0.2/0.2 | Trigonox ® A80/ | 2.8 | 148 G | | |
| | | | Trigonox ® B | | | | |
| 6 | 0.6 | 0.3 | Dicumyl peroxide | 5.0 | 158 K | | |
| 7 | 0.6 | 0.4 | Trigonox ® B | 14.0 | 148 G | | |

TABLE 2
Bulk density as function of the foaming time

| Foaming | | | | |
|---|---|---|---|---|
| time [sec] | C1 | C2 | Example 3 | Example 4 |
| 2 | 20.0 | | 21.0 | 18.6 |
| 4 | 16.1 | 22.4 | 16.5 | 13.2 |
| 5 | | 19.2 | | 12.5 |
| 6 | 13.5 | 18.5 | 13.9 | 13.5 |
| 8 | 14.7 | 16.7 | 14.8 | 15.2 |
| 10 | 17.9 | 15.6 | 17.7 | |

1. A process for producing flame-resistant, expandable styrene polymers (EPS), in which an organic bromine compound having a bromine content of at least 70% by weight is used as flame retardant and a liquid peroxide, hydroperoxide or a peroxide solution is used as flame retardant synergist, wherein the flame retardant is premixed with a proportion of styrene polymer melt in a side extruder and metered into the main stream of a styrene polymer melt containing blowing agent and the flame retardant synergist is metered by means of a pump into the main stream and the combined stream is extruded through a die plate with subsequent underwater pelletization.

2. The process according to claim 1, wherein the flame retardant synergist is selected from the group consisting of di-tert-butyl peroxide, tert-butyl hydroperoxide, a solution of dicumyl peroxide in pentane and mixtures thereof.

3. The process according to claim 1, wherein the flame retardant is hexabromocyclododecane.

4. The process according to claim 1, wherein the residence time of the flame retardant and of the flame retardant synergist at a melt temperature in the range from 140 to 220° C. is less than 15 minutes.

5. The process according to claim 4, wherein the residence time of the flame retardant and of the flame retardant synergist at a melt temperature in the range from 170 to 200° C. is less than 15 minutes.

6. The process according to claim 2, wherein the flame retardant is hexabromocyclododecane.

7. The process according to claim 2, wherein the residence time of the flame retardant and of the flame retardant synergist at a melt temperature in the range from 140 to 220° C. is less than 15 minutes.

8. The process according to claim 3, wherein the residence time of the flame retardant and of the flame retardant synergist at a melt temperature in the range from 140 to 220° C. is less than 15 minutes.

9. The process according to claim 7, wherein the residence time of the flame retardant and of the flame retardant synergist at a melt temperature in the range from 170 to 200° C. is less than 15 minutes.

10. The process according to claim 8, wherein the residence time of the flame retardant and of the flame retardant synergist at a melt temperature in the range from 170 to 200° C. is less than 15 minutes.

11. The process as claimed in claim 1, wherein the expandable styrene polymer has a molecular weight in the range of 190,000 to 400,000 g/mol.

12. The process as claimed in claim 1, wherein the expandable polymer has a polydispersity (M_{w}/Mₙ) of not more than 3.5.

13. The process as claimed in claim 1, wherein the blowing agent is present in a total amount of from 2 to 10% by weight based in the styrene polymer melt containing blowing agent.

14. The process as claimed in claim 1, wherein water is added to the styrene polymer melt before, together or after the addition of blowing agent.

15. The process as claimed in claim 1, wherein the expandable styrene polymers are selected from the group consisting of GPPS, HIPS, A-IPS, ABS, SAN, ASA, MBS, MABS and mixtures thereof which are optionally blended with other polymers.
